(19) United States
(12) Patent Application Publication
(10) Pub. No.: US 2019/0058171 A1
(43) Pub. Date: Feb. 21, 2019

(54) BATTERY PACK FOR A HAND-HELD POWER TOOL

(71) Applicant: Robert Bosch GmbH, Stuttgart (DE)

(72) Inventor: Marcin Rejman, Waiblingen (DE)

(21) Appl. No.: 16/079,461

(22) PCT Filed: Feb. 21, 2017
(86) PCT No.: PCT/EP2017/053872

§ 371 Date: Aug. 23, 2018

(30) Foreign Application Priority Data
Mar. 2, 2016 (DE) 10 2016 203 429.4

(51) Int. Cl. H01M 2/10; H01M 10/48; B25F 5/02

(52) U.S. Cl. CPC H01M 2/105; H01M 2/1077; H01M 2010/4271; B25F 5/02; H01M 10/482

(57) ABSTRACT

A battery pack is described for a handheld power tool, the battery pack having a battery pack housing and at least one cell holder. The cell holder accepts at least one battery cell. The battery pack housing has at least one foldable hinge, the hinge connecting a first element and a second element to one another. The first element and the second element are made in one piece and pivotable relative to one another.

### FIELD OF THE INVENTION

The present invention relates to a battery pack for a handheld power tool.

BACKGROUND INFORMATION

Electrical handheld power tools are known in principle, and are supplied with power via a mains connection. Alternatively, battery-powered devices enable a high degree of flexibility during work, in particular because they are independent of mains power. In this way, for example outdoor work can also comfortably be carried out, so that battery packs are often used when operating a handheld power tool.

Such battery packs are known in principle and, as a rule, have a plurality of rechargeable accumulators connected in parallel and/or in series, for example three cylindrical lithium-ion cells connected in series, each having for example 3.6 V, with an overall voltage of 10.8 V. In the context of the present application, a battery pack is thus to be understood as a packet of accumulators, preferably made up of a plurality of accumulator cells connected together electrically, that can store electrical energy that provides the energy required for the operation of a handheld power tool, and can be exchangeably housed in a chamber or an interface or the like of the handheld power tool. The connected battery cells have to be connected on the one hand to the battery pack electronics unit, and on the other hand to one another. Here, for the series connection, in part so-called conductor plates and/or cables are used that are soldered to the respective complementary poles of a battery cell and connect these to one another.

The battery cell has to be connected to the battery pack electronics unit, and when there is a plurality of battery cells these have to be connected to one another on the one hand and to the battery pack electronics unit on the other hand. Here, for the series connection, in part so-called conductor plates and/or cables are used that are soldered to the respective complementary poles of a battery cell and connect these to one another. The conductor plates and/or cables are connected to the cell connectors via conductive adhesive connections.

As a rule, the battery pack includes the battery pack housing in which the cell holder is accommodated either completely or partly. Alternatively, the cell holder itself forms a battery pack housing element of the battery pack housing. Here it turns out to be disadvantageous that the individual battery pack housing components have to be connected to one another via various connecting elements, in particular by screw connections or snap connections.

### SUMMARY

An object of the present invention is to remedy the above-named disadvantages, and to provide an improved battery pack for a power tool of the type named above, in which the battery pack housing can be assembled as quickly and easily as possible and at the lowest possible cost.

According to the present invention, it is provided that a battery pack for a handheld power tool has a battery pack housing and at least one cell holder, the cell holder accepting at least one battery cell. In addition, the battery pack housing has at least one foldable hinge, the hinge connecting a first element and a second element to one another. Here it is provided that the first element and the second element are made in one piece and pivotable relative to one another. In this way, two or more battery pack housing components can be connected to one another. The battery pack housing components are mounted so as to be rotatable relative to one another.

Advantageously, the cell holder accepts a plurality of battery cells connected to one another in a parallel circuit and/or in a series circuit; in a specific embodiment, each battery cell has a cladding surface that runs parallel to a longitudinal axis, the cladding surface being bounded by two end faces standing perpendicular to the longitudinal axis, so that the cladding surface and the end faces form an outer sheath of the battery cell.

In a particularly preferred specific embodiment, the battery pack housing includes the cell holder, the cell holder having the hinge. The use of a battery pack according to the present invention facilitates installation and reduces the number of parts. Here it is advantageous if the at least one hinge is a film hinge, because film hinges in particular can be use as assembly aids, in particular as positioning and holding aids, such that for example electronics boards, cable guides, cell connectors, fuses, or other electronic components can be positioned detachably or permanently in their position.

Preferably, the battery pack housing has in addition at least one further connecting device that fixes the hinge in its position or holds it in an arrested position. Here it is advantageously provided that the further connecting device is a snap connection, a plug connection, and/or a screw connection, so that the battery pack housing components, mounted so as to be rotatable relative to one another via the hinge, can be fixed in their position relative to one another via the additional connecting device. In a particularly preferred embodiment, this connecting device is at least one locking tab situated on the first element and a locking element situated on the second element, so that through the further connecting device there advantageously arises a positive-fit connection and/or a non-positive-fit connection between the first element and the second element.

In addition, the battery pack includes a battery pack electronics unit, the battery pack electronics unit having at least one circuit board having contact elements for producing an electrical connection between the battery pack and the handheld power tool. Alternatively or in addition, it can be provided that the battery pack has a further circuit board, in particular a flexible circuit board, on which at least one contact means is situated that corresponds to the battery cell.

Preferably, the contact means electrically contacts the corresponding battery cell on the cladding surface in such a way that an additional contacting of the individual battery cells to the battery pack electronics unit via a conductor can be omitted. Here, the contact means can be connected to the circuit board via a welded or soldered connection, thus achieving a particularly simple and reliable mechanical and electrical contacting. In addition, a tolerance compensation, and a thermal expansion compensation, can also be achieved through a correspondingly realized welded connection.

Advantageously, the battery pack electronics has a microcontroller that is electrically connected to the contact means and is configured to acquire at least one operating parameter of the individual battery cell via the at least one contact means. Using the microcontroller of the battery pack electronics unit, inter alia the charge state can be monitored via the voltage of the individual battery cells, and can be controlled by a corresponding regulating unit. Correspondingly, an individual cell monitoring can take place, individual battery cells being connectable directly to the circuit board of the battery pack electronics unit via the contact means. Such a connection can take place for example via a soldered connection, and the battery pack electronics unit can advantageously have corresponding solder pads. In this way, on the basis of the connection between the battery cells and the circuit board, it can be determined whether all battery cells have been properly charged, or whether a charge current has been reached that the battery cells are not capable of absorbing. In addition, a regulation can be provided by which the charge current can be regulated in such a way that on the one hand an overloading of individual battery cells is prevented and on the other hand all the battery cells can be completely charged. In this way, good serviceability of the corresponding battery pack over a long period of time is achieved.

According to the present invention, it is provided that the hinge fastens the at least one circuit board to the battery pack housing and/or to the cell holder, the circuit board, in particular the flexible circuit board, being clamped between the first element and the second element. In a preferred embodiment, the battery pack housing and/or the cell holder, but in particular the second element, has at least one viewing area for indicating the charge state of the battery cells, the battery pack housing and/or the cell holder, and in particular the second element, advantageously having a plurality of viewing areas so that different states of charge of the battery cells can be indicated via the various viewing areas.

The described optimized embodiment of the battery pack according to the present invention in particular improves its installation, or the positioning and installation of various components, in particular of the circuit boards, the cable guides, the cell connectors, and/or the electronics fuses inside the battery pack housing.

In principle, various specific embodiments of a cell holder can be used inside the battery pack, so that battery cells having different diameters and lengths can be accommodated, and the usability of the cell holder in different battery packs can be ensured.

As battery cells for a battery pack, various accumulator types having different materials may be used, such as lithium-ion (Li-ion), nickel-cadmium (NiCd), nickel-metal hydride (NiMH), or lithium-polymer (LiPo); different constructive shapes may be used, such as round, prismatic, or cornered shapes; or other alternative systems, such as fuel cells, may be used. Preferably, in particular lithium-ion cells are used, because with lithium-ion cells it is in particular possible to combine a plurality of battery cells to form battery cell blocks in which a plurality of battery cells are connected in a parallel circuit. Here it is particularly advantageous if the cell holder can accept battery cells having different diameters and lengths, so that as a result the cell holder, or cell bearer, can be used in different battery packs.

The battery pack according to the present invention can also be used in a tool system. Correspondingly, a handheld power tool that includes a battery pack detachably connectable to the handheld power tool forms a further subject matter of the present invention, the handheld power tool having at least one corresponding counter-contact element for electrical and/or mechanical connection to the interface of the battery pack.

In general, a handheld power tool is to be understood as any handheld power tool having a tool holder that can be driven by a drive motor, for example can be set into rotation and/or oscillation, such as a rod screwdriver, a battery drill, impact drills, multifunction tools, handheld vacuum cleaners, mixers, and/or drill screwdrivers. In the present context, the transmission of electrical energy is to be understood in particular as meaning that the handheld power tool is provided with energy by a battery and/or a power cable connection.

Quite generally, an electric motor is to be understood as any type of electrical consumer, such as an EC motor, a linear drive, a lamp, a pump, a ventilator, a compressor, or the like. The advantage of the brushless DC motors is, inter alia, that on the one hand they are nearly maintenance-free, and due to their high efficiency they enable longer working time per battery charge during battery operation, so that they are particularly efficient. In addition, handheld power tools having EC motors can be made very compact and light, and it is particularly advantageous that there is also less heat loss, so that the devices do not heat up as much as comparable devices, and therefore have longer life.

Further features, possible uses, and advantages of the present invention result from the following description of the exemplary embodiments of the present invention, shown in the Figures. Here it is to be noted that the depicted features have only a descriptive character, and can also be used in combination with features of other further developments described above, and are not intended to limit the present invention in any way.

### BRIEF DESCRIPTION OF THE DRAWINGS

FIG. 1 shows as an example a view of a power tool having a battery pack according to the present invention.

FIG. 2 shows a perspective exploded view of a first specific embodiment of a battery pack according to the present invention.

FIG. 3 shows a perspective view of a cell holder for a battery pack according to the present invention.

FIG. 4 shows a perspective view of the cell holder of FIG. 3, with a battery pack electronics unit situated therein.

### DETAILED DESCRIPTION

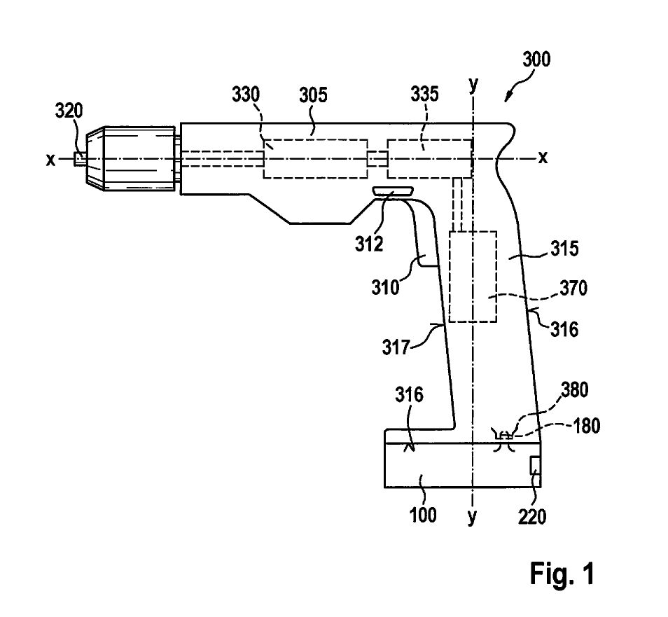

FIG. 1 shows an electrical device fashioned as handheld power tool 300, realized for example as a battery-powered drill screwdriver. Correspondingly, in the depicted specific embodiment handheld power tool 300 is mechanically and electrically connected to a battery pack 100 in order to supply power independent of the mains network. However, it is to be noted that the present invention is not limited to battery-powered drill screwdrivers, but rather can be used in various handheld power tools 300, regardless of whether they are operated, as shown, with a battery pack 100 as a mains-independent power supply, or are operated with a mains-dependent power supply. Handheld power tool 300 has a gear mechanism 330 situated in a housing 305 for transmitting a torque produced by a drive motor 335 to a driveshaft that rotates about an axis x, to which shaft a tool chuck 320 for a tool (not shown) is fastened; power tool 300 also has a handle 315. Inside housing 305, there is situated an electronics unit 370 that stands in electronic and mechanical contact with drive motor 335 and/or with gear mechanism 330. Handle 315 acts as a support surface for the hand of an operator of handheld power tool 300, and generally has a longitudinal axis y, a front side 317 that points along an axis x in the direction of tool chuck 320, a rear side 316, and two side surfaces 318.

In the area of handle 315, there is situated a first operating element 310 for supplying energy to drive motor 335, first operating element 310 protruding from housing 305 so as to be manually accessible by the user, so that, in a known manner, through a pressure movement of first operating element 310, a controlling and/or regulation of the drive motor can be enabled, preferably as a function of the path of displacement of first operating element 310, and the supply voltage to drive motor 335 can also be switched on and/or off. In addition, handheld power tool 300 has a second operating element 312 in the form of a sliding switch for setting the direction of rotation of drive motor 335 of handheld power tool 300. Second operating element 312 is situated so as to be displaceable perpendicular to axis of rotation x of the driveshaft, in particular of tool chuck 320 of handheld power tool 300, so that upon actuation the second operating element 312 can be moved back and forth between a first position, a second position, and a third position. Here, the first and second position each determine a direction of rotation of the drive motor. In this way, the user of handheld power tool 300 can recognize, already on the basis of the positions of second operating element 312, the operating mode in which handheld power tool 300 is operating. In addition, the second switching element has a third position, for example a center position, between the first position and the second position, such that in the third position there is an electrical, electromechanical, and/or mechanical interruption of the motor current. In this way for example the operation of first switching element 310 can be mechanically blocked, second operating element 312 acting, when moved into a third position, in a locking manner on first switching element 310. Here, second operating element 312 can be realized, as shown, as a sliding switch, or alternatively as a rocker switch.

First operating element 310 and second operating element 312 are situated along axis of rotation x in such a way that it is possible to actuate both first and second operating element 310, 312 using the index finger or middle finger. Here, the distance between first operating element 310 and second operating element 312 is selected such that one-handed operation of handheld power tool 300 is possible. In addition, both operating elements 310, 312 are situated in a region below axis of rotation x, and protrude from housing 305.

In the position shown in FIG. 1, battery pack 100 is fastened on handle 315 of handheld power tool 300, and is locked by locking means. The situation of battery pack 100 below handle 315 does not disturb the operation of handheld power tool 300. The locking means, not shown in detail, include, inter alia, a locking element and an actuating element 220. By actuating the actuating means 220, battery pack 100 can be detached from handle 315 of handheld power tool 300. In addition, handheld power tool 300 has an interface 380.

Battery pack 100 shown in FIG. 1 is realized as a sliding battery pack, and has an interface 180 that corresponds to interface 380 of handheld power tool 300. Alternatively to the sliding battery pack, a realization as a rotating or pivoting battery pack is also possible, in which battery pack 100 can be detachably arrested on housing 305 of handheld power tool 300 on the side opposite the pivot axis by locking, screwing, clamping, or tensioning. In this way, the possibility of the battery pack falling off of housing 305 can effectively be counteracted.

For the detachable attachment of battery pack 100 on a handheld power tool 300, or to a charge device, battery pack 100 has an interface 180 for detachable mechanical and electrical connection to a corresponding interface 380 of handheld power tool 300 or a corresponding interface of the charge device. During the attachment of battery pack 100, receptacle means, e.g.

guide grooves and guide ribs, of handheld power tool 300 or of the charge device, for accepting the corresponding guide elements of battery 100, are brought into engagement therewith, battery pack 100 being introduced along the receptacle means and interface 180 of battery pack 100 being pushed into the corresponding interface 380 of handheld power tool 300 or the corresponding interface of the charge device. Via interfaces 180, 380, battery pack 100 can be assigned to handheld power tool 300 and/or to the charge device.

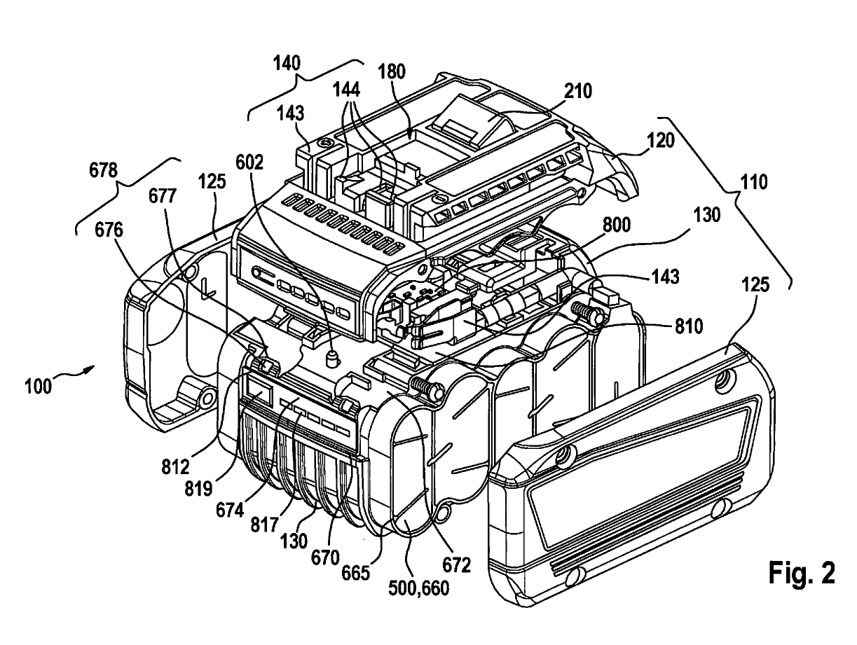

In order to lock battery pack 100 on handle 315 of handheld power tool 300, battery pack 100 is pushed along handle 315, along an outer surface of handle 315 oriented essentially perpendicular to longitudinal direction y of handle 315. In the position shown in FIG. 1, battery pack 100 is locked to handle 315 by locking means. The locking means include, inter alia, a locking element 210, shown in FIG. 2, and an actuating element 220. By actuating the actuating means 220, battery pack 100 can be detached from handle 315 of handheld power tool 300.

FIG. 2 shows a battery pack 100 in an exploded view. Battery pack 100 has a housing 110 made up of a first housing component 120 and a second housing component 130. Here it can be clearly seen that battery pack housing 110 in addition has a cell holder 600 having a plurality of battery cells (not shown in detail) connected in a series circuit, second housing component 130 immediately forming cell holder 600. Cell holder 600 is positioned between the two housing components 120, 130. Battery pack housing 110 additionally has two side components 125 that, in the assembled state, hold together first housing component 120 and second housing component 130, or cell holder 600, in such a way that detachment of first housing component 120 from second housing component 130, or vice versa, is prevented. Battery pack 100 is realized as a sliding battery pack in the variant embodiment shown in FIG. 2.

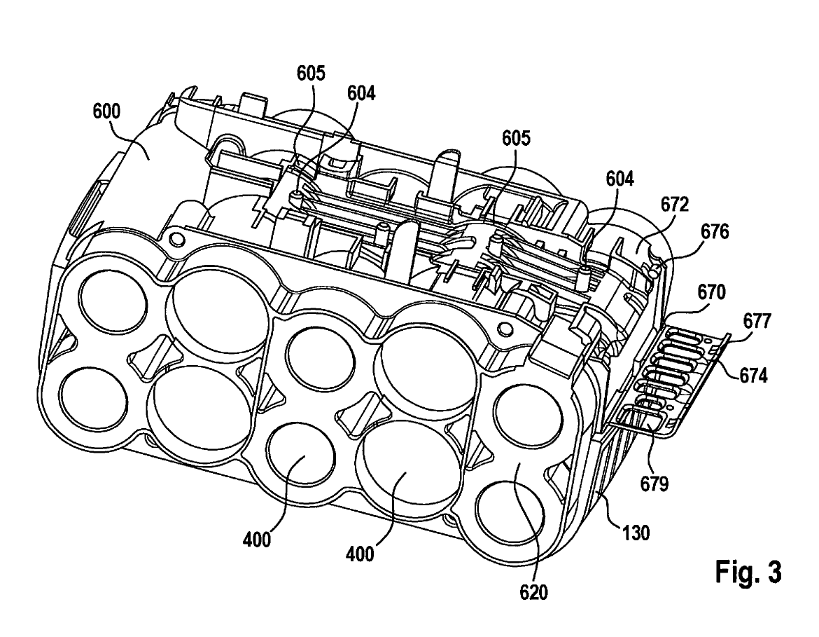

In addition to the fixing of battery cells 400 in battery pack housing 120, 130, cell holder 600 is also responsible for the cooling of battery cells 400, and is made of a thermally conductive material, for example aluminum or a plastic. As can be seen in FIG. 3, cell holder 600 additionally has sleeve-shaped insulating walls, so that the individual battery cells 400 can be separated, and an electrical insulation of the individual battery cells 400 from one another can be ensured. The heat transfer resistance between adjacent battery cells 400, and between battery cells 400 and cell holder 600, is here as low as possible, so that the lost heat produced by battery cells 400 can be effectively conducted to the outside, and overheating in the interior of the battery pack can be prevented. In the depicted specific embodiment, cell holders 600 have at least one foldable hinge 670. Hinge 670 connects a first element 672 of cell holder 600, or of battery pack housing 110, to a second element 674 of cell holder 600 or of battery pack housing 110, first element 672 and second element 674 being made in one piece and pivotable relative to one another, as film hinge 670. In this way, two or more battery pack housing components can be connected to one another, the two battery pack housing components being mounted rotatably relative to one another. Film hinges 670 can be used during the assembly of battery pack 100 as assembly aids, in particular as positioning and holding aids, so that for example circuit boards 810, 812, cable guides, cell connectors, fuses, and/or other electronic components can be positioned detachably and/or permanently in their position on battery pack 100, or inside battery pack housing 110.

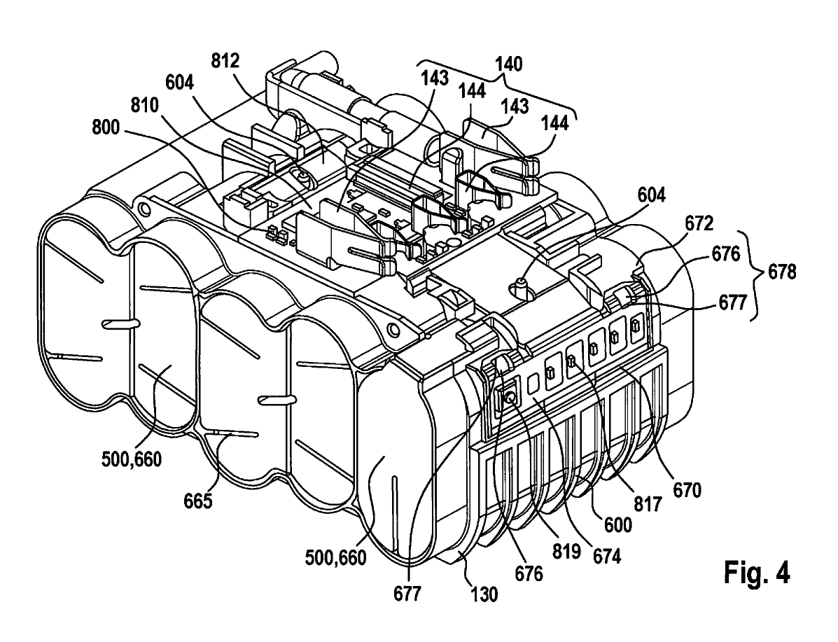

As can be seen in particular in FIG. 4, battery pack electronics unit 800 has at least one flexible circuit board 812 having at least one contact means corresponding to battery cell 400, flexible circuit board 812 being clamped between first element 672 and second element 674 in the depicted specific embodiment. In addition, cell holder 600 has a plurality of positioning elements 604 for holding flexible circuit board 812 in its position, positioning elements 604 engaging in corresponding recesses 816 of flexible circuit board 812 in the installed state. In order to hold the hinge in an arrested position, in the depicted variant embodiment battery pack housing 110 has two further connecting devices 678. Further connecting device 678 can be a snap connection, a plug connection, and/or a screw connection. In the case of a snap connection, connecting device 678 has at least one locking tab 676 situated on first element 672, and has a locking element 677 situated on second element 674, so that after assembly has taken place connecting device 678 enters into a positive-fit connection and/or a non-positive-fit connection between first element 672 and second element 674.

Second element 674 has a plurality of viewing areas 679, each of which indicates a different state of charge of battery cells 400. For this purpose, flexible circuit board 812 has a plurality of electrical components, in particular at least one actuating element 819 and a plurality of display lights 817. After flexible circuit board 812 has been installed between first element 672 and second element 674, viewing areas 679 in the region of second element 674 enable display of the various states of charge of battery cells 400.

The use of film hinges facilitates and accelerates the installation of battery pack housing 110, and in addition components are reduced, so that a very convenient joining method is enabled through the use of such a hinge. For example, with a film hinge circuit boards 810, 812, cable guides, cell connectors 500, fuses, or other electronic components can be positioned and subsequently arrested in their position either permanently or detachably.

The connection of battery cells 400 among one another is realized through cell connectors 500, shown in particular in FIGS. 2 and 4. Through cell connectors 500, an electrical connection of battery cells 400 to one another in a parallel circuit and/or a series circuit can be carried out. In the specific embodiments shown in FIGS. 2 and 4, it can in addition be seen that inside battery pack housing 110, a circuit board 810 having a battery pack electronics unit 800 is fastened on the surface of cell holder 600. On circuit board 810, there are situated contact elements 140 for producing the electrical and mechanical connection between battery pack 100 and handheld power tool 300, or between battery pack 100 and the charge device. Here, contact elements 143 are fashioned as voltage contact elements, and act as charging or discharging contact elements, while contact elements 144 are fashioned as signal contact elements and are used for signal transmission from battery pack 100 to handheld power tool 300 or to the charge device, and/or from handheld power tool 300 or the charge device to battery pack 100.

In addition, in FIGS. 2 and 4 cell connectors 500 are shown through which an electrical connection of battery cells 400 to one another in a parallel and/or series circuit can be carried out. Here, the individual battery cells 400 are accommodated at a distance from one another for mechanical fixing in cell holder 600. Each battery cell 400 has a cladding surface running parallel to a longitudinal axis x, the cladding surface being bounded by two end faces standing perpendicular to longitudinal axis x, on which the electrical poles of battery cells 400 are situated.

It is fundamentally advantageous if, as shown in FIGS. 2 and 4, cell holder 600 forms in some regions an external side of battery pack housing 110, in particular forming second housing component 130. In addition, it is advantageous if side components 125 are made of the same material as the rest of battery pack housing 110, preferably a synthetic technically usable thermoplastic material, such as a polyamide. In this way, costs can be reduced and the assembly outlay can be kept low.

Alternatively, side components 125 can be made at least partly of a metal, preferably die-cast aluminum or magnesium; in this case, an adequate, or reliable, insulating insert, for example an elastic thermally conductive element 650, is used between cell connectors 500 and side components 125. The elastic thermally conductive element 650 is advantageously situated between the end faces of battery cells 400 and a wall of battery pack housing 110 running essentially parallel to the end faces of battery cells 400, so that there results a thermal contact with the end faces of battery cells 400, and heat is carried away from battery cells 400 in the direction of the walls of battery pack housing 110. Elastic thermally conductive element 650 is advantageously made at least partly of a heat-conducting material that belongs to at least one of the material groups of the elastomers, the thermoplastic elastomers, or the carbon fibers. In this way, it can be ensured that elastic thermally conductive element 650 on the one hand has a thermal conductivity that is greater than 0.15 W/mK, preferably greater than 0.20 W/mK, and particularly preferably is between 0.20 W/mK and 0.50 W/mK, and on the other hand has a Shore hardness that is less than 50 Shore A and is preferably between 20 Shore A and 45 Shore A.

In addition, it is advantageous if elastic thermally conductive element 650 stands in immediate thermal contact with the respective side component 125, elastic thermally conductive element 650 being situated immediately in side component 125 of battery pack housing 110, or even being made in one piece therewith. If side components 125 are made of the same material as the rest of battery pack housing 110, preferably a synthetic technically usable thermoplastic material, such as a polyamide, this makes it possible for elastic thermally conductive element 650 to be produced together with side component 125 in an injection molding method, for example a 2K injection molding method, preferably in a common working process, and in particular in one piece. In this way, costs can be reduced and the assembly outlay can be kept low. Advantageously, elastic thermally conductive element 650 is made at least partly of a thermally conductive material, such as an elastomer or a thermoplastic elastomer. Thermal expansion element 660, or cell connectors 500, thus stand in thermal contact both with elastic thermally conductive element 650 and with the wall of battery pack housing 110, and thus provide a uniform application of heat to the wall of battery pack housing 110.

In the specific embodiments shown in FIGS. 2 and 4, it can in addition be seen that in the region of the end faces of battery cells 400, between elastic thermally conductive element 650 and the wall of battery pack housing 110, cell conductors 500 are made with a large enough surface that, in addition to their function of ensuring an electrical connection of battery cells 400 among one another in a parallel and/or series circuit, they also perform the function of a thermal expansion element 660, and are capable of supporting the desired heat transfer. Although it is not shown in detail in the Figures, it is advantageous for thermal expansion element 660 and cell connector 500 to be made as a composite component, in particular a one-piece composite component, and to have slot-shaped openings 665 in the regions in which the heat transfer is undesirable and is to be prevented to as great an extent as possible, one opening 665 being provided for each battery cell 400. In this way, it can be ensured that the lost heat transmitted at points from battery cells 400 to cell connectors 500, or to thermal expansion element 660, can be transferred immediately to elastic element 650 standing in thermal contact with cell connectors 500; due to openings 665, cell connectors 500, realized as thermal expansion element 660, distribute the lost heat, transferred at points, to the entire surface and to elastic element 650.

In the regions in which the heat transfer is not desired and is to be prevented to the greatest possible extent, thermal expansion element 660 has a plurality of openings 665. These are distributed over the entire surface of thermal expansion element 660, one opening 665 being provided for each battery cell 400 in the depicted specific embodiment. In this way, it can be ensured that the lost heat, transmitted from battery cells 400 at points to elastic element 650 standing in thermal contact with battery cells 400, can be transmitted immediately to the immediately adjacent thermal expansion element 660 standing in thermal contact with elastic element 650. Due to openings 665, thermal expansion element 660 distributes the lost heat, transferred in relatively point-like fashion, to the entire surface of the respective side components 125 of battery pack housing 110, thermal expansion element 660 also standing in immediate thermal contact with the respective side component 125.

In addition to the described and depicted specific embodiments, additional specific embodiments are possible that may include further modifications and combinations of features.

1-12. (canceled)

13. A battery pack for a handheld power tool, comprising:
a battery pack housing; and
at least one cell holder, wherein:
the cell holder accepts at least two battery cells connected to one another in at least one of a parallel circuit and a series circuit,
the battery pack housing includes at least one foldable hinge,
the hinge connects a first element and a second element to one another, and
the first element and the second element are made in one piece and pivotable relative to one another.

14. The battery pack as recited in claim 13, wherein:
the battery pack housing includes the cell holder, and
the cell holder includes the hinge.

15. The battery pack as recited in claim 13, wherein the hinge is a film hinge.

16. The battery pack as recited in claim 13, wherein the battery pack housing includes at least one further connecting device that holds the hinge in an arrested position.

17. The battery pack as recited in claim 16, wherein the further connecting device is at least one of a positive-fit connection and a non-positive-fit connection.

18. The battery pack as recited in claim 16, wherein the further connecting device includes at least one of a snap connection, a plug connection, and a screw connection.

19. The battery pack as recited in claim 16, wherein the connecting device includes:
at least one locking tab situated on the first element, and
a locking element situated on the second element.

20. The battery pack as recited in claim 13, wherein at least one of the battery pack housing and the cell holder has at least one viewing area for indicating a state of charge of the battery cells.

21. The battery pack as recited in claim 13, wherein the second element has at least one viewing area for indicating a state of charge of the battery cells.

22. The battery pack as recited in claim 13, wherein at least one of the battery pack housing and the cell holder has a plurality of viewing areas that each indicate a different state of charge of the battery cells.

23. The battery pack as recited in claim 13, wherein the second element has a plurality of viewing areas that each indicate a different state of charge of the battery cells.

24. The battery pack as recited in claim 13, further comprising:
battery pack electronics unit that includes at least one of:
at least one circuit board having at least one contact element for producing an electrical connection between the battery pack and the handheld power tool, and
a flexible circuit board having at least one contact element corresponding to the battery cell.

25. The battery pack as recited in claim 24, wherein the at least one of the circuit board and the flexible circuit board is capable of being clamped between the first element and the second element.

26. A handheld power tool, comprising:
a housing having a handle;
a drive motor situated in the housing for driving a mechanical interface,
a first electronics unit situated in the housing; and
a battery pack capable of being connected detachably to the handheld power tool, the battery pack being connected electrically to the handheld power tool in an installed state, wherein the battery pack includes:
a battery pack housing, and
at least one cell holder, wherein:
the cell holder accepts at least two battery cells connected to
one another in at least one of a parallel circuit and a series circuit,
the battery pack housing includes at least one foldable hinge,
the hinge connects a first element and a second element to one another, and
the first element and the second element are made in one piece and pivotable relative to one another.
